(19) United States
(12) Patent Application Publication
(10) Pub. No.: US 2008/0136580 A1
(43) Pub. Date: Jun. 12, 2008

(54) CHIP NETWORK RESISTOR CONTACTING PCB THROUGH SOLDER BALLS AND SEMICONDUCTOR MODULE HAVING THE SAME

(75) Inventors: Hyo-Jae BANG, Chungcheongnam-do (KR); Dong-Chun LEE, Chungcheongnam-do (KR); Seong-Chan HAN, Chungcheongnam-do, (KR); Jung-Hyeon KIM, Gyeonggi-do (KR); Hyun-Seok CHOI, Chungcheongnam-do, (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Gyeonggi-do (KR)

(21) Appl. No.: 11/947,422

(22) Filed: Nov. 29, 2007

(30) Foreign Application Priority Data
Dec. 11, 2006 (KR) 2006-0125656

(51) Int. Cl. H01C 1/01

(52) U.S. Cl. 338/320

(57) ABSTRACT

Provided are a chip network resistor contacting a printed circuit board (PCB) through solder balls and a semiconductor module having the chip network resistor. The chip network resistor includes: a body formed of an insulating material; a resistor formed on the body; external electrodes connected to the resistor and disposed on a lower surface of the body so as to have solder ball pad shapes; and conductive balls adhered on the external electrodes.

### CROSS-REFERENCE TO RELATED PATENT APPLICATION

This application claims priority under 35 USC §119 to Korean Patent Application No. 10-2006-0125656, filed on Dec. 11, 2006, in the Korean Intellectual Property Office, the disclosure of which is incorporated herein in its entirety by reference.

### BACKGROUND

1. Technical Field

The present invention relates to a chip network resistor and a semiconductor module having the same, and more particularly, to a chip network resistor contacting a printed circuit board (PCB) through solder balls and a semiconductor module having the same.

2. Description of the Related Art

A chip network resistor refers to a resistor into which a plurality of resistors is integrated in a semiconductor package form to improve integration of an electronic product. In the chip network resistor, there are a plurality of resistors, but the plurality of resistors are integrated into a single body. Thus, the chip network resistor includes exposed leads. When such a chip network resistor is mounted on a printed circuit board (PCB), the number of assembled parts can be reduced. In particular, the chip network resistor can be conveniently assembled. However, the chip network resistor is high-priced and requires management of both temperature and time during soldering.

In recent years, the sizes of personal computers (PCs) and servers have been reduced. However, the ability to reduce the sizes of semiconductor modules inserted into the PCs and the servers, e.g., memory modules, is limited. Thus, a resistor used in a memory module uses a passive device having high integration like a chip network resistor. The chip network resistor is used to reduce noise of a signal wave reflected from a semiconductor package inserted into a memory module. However, when the chip network resistor is mounted on a PCB used for the memory module, several quality problems may occur in the chip network resistor. Thus, the chip network resistor needs to be improved.

FIG. 1 is a plan view of a chip network resistor according to the prior art, and FIG. 2 is a cross-sectional view of the chip network resistor of FIG. 1, mounted on a PCB. Referring to FIGS. 1 and 2, a chip network resistor 10 according to the prior art includes a body 12 having convex parts 14 and concave parts 16 and thus has an uneven structure. A resistor structure 20 is formed on the body 12. The resistor structure 20 extends through a wire line 18 installed at the convex parts 14 beside and underneath the body 12 to be used as an external electrode as shown in FIG. 2.

The chip network resistor 10 is mounted on a PCB 30 as shown in FIG. 2. The chip network resistor 10 is electrically bonded to the PCB 30 through the wire line 18 positioned on a side and a lower part of the chip network resistor 10. Here, a stand off height of the chip network resistor 10 is small, i.e., about 30 μm.

However, in the chip network resistor 10, a crack 22 may occur in the body 12 due to an external impact or a visual defect 24 may occur in the wire line 18, i.e., a portion of a conductive material plated on the wire line 18 may be stripped. Also, the chip network resistor 10 is soldered through the wire line 18 formed on the side of the chip network resistor 10. Thus, a crack 28 may occur in a soldering part 26 due to a side stress caused by a difference in a thermal expansion coefficient occurring in an inspection of reliability, such as a temperature cycle. The present invention addresses these and other disadvantages of the conventional art.

### SUMMARY

Embodiments of the present invention provide a chip network resistor which includes improved external electrodes and has a lower part bonded to a printed circuit board (PCB) and contacts the PCB through solder balls. The present invention minimizes the occurrence of defects and improves the reliability of solder bonding. A semiconductor module having the chip network resistor is also provided.

According to an aspect of the present invention, there is provided a chip network resistor, including: a body comprising an insulating material; a resistor disposed on the body; external electrodes connected to the resistor and disposed on a lower surface of the body; and conductive balls adhered on the external electrodes.

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view of a chip network resistor according to the conventional art;

FIG. 2 is a cross-sectional view of the chip network resistor of FIG. 1 mounted on a printed circuit board (PCB);

FIG. 3 is a perspective view of a chip network resistor contacting a PCB through solder balls according to an embodiment of the present invention;

FIG. 4 is a bottom view of the chip network resistor of FIG. 3;

FIG. 5 is a front view of the chip network resistor of FIG. 3 viewed from direction A;

FIG. 6 is a perspective view of a chip network resistor contacting a PCB through solder balls according to another embodiment of the present invention;

FIG. 7 is a bottom view of the chip network resistor of FIG. 6;

FIG. 8 is a front view of the chip network resistor of FIG. 6 viewed from direction B;

FIG. 9 is a perspective view of a chip network resistor contacting a PCB through solder balls according to another embodiment of the present invention;

FIG. 10 is a perspective view of a chip network resistor contacting a PCB through solder balls according to yet another embodiment of the present invention;

FIG. 11 is a plan view of a chip network resistor contacting a PCB through solder balls according to still another embodiment of the present invention;

FIG. 12 is a bottom view of the chip network resistor of FIG. 11;

FIG. 13 is a side view of the chip network resistor of FIG. 11;

FIG. 14 is a front view of the chip network resistor of FIG. 11 viewed from direction D;

FIG. 15 is a plan view of a semiconductor module including a chip network resistor contacting a PCB through solder balls according to some embodiments of the present invention;

FIG. 16 is a graph illustrating dissipation energy of a chip network resistor having a structure as illustrated in FIG. 2 in an inspection of reliability; and

FIG. 17 is a graph illustrating dissipation energy of a chip network resistor having a structure as illustrated in FIG. 14 in an inspection of reliability.

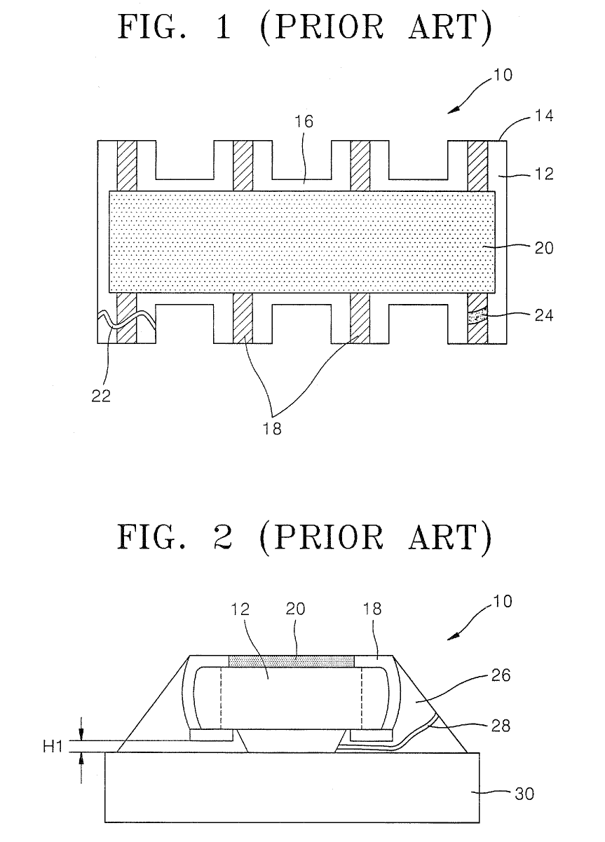

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

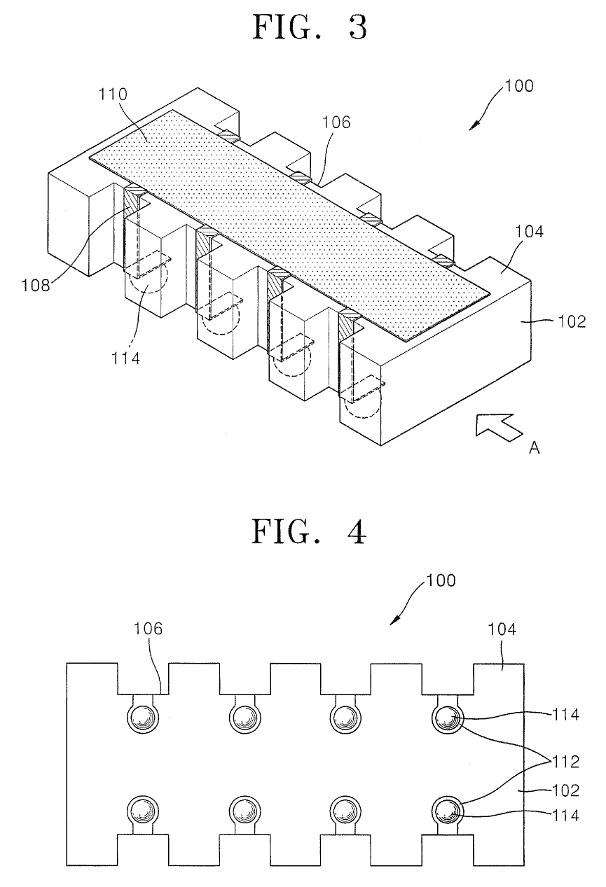

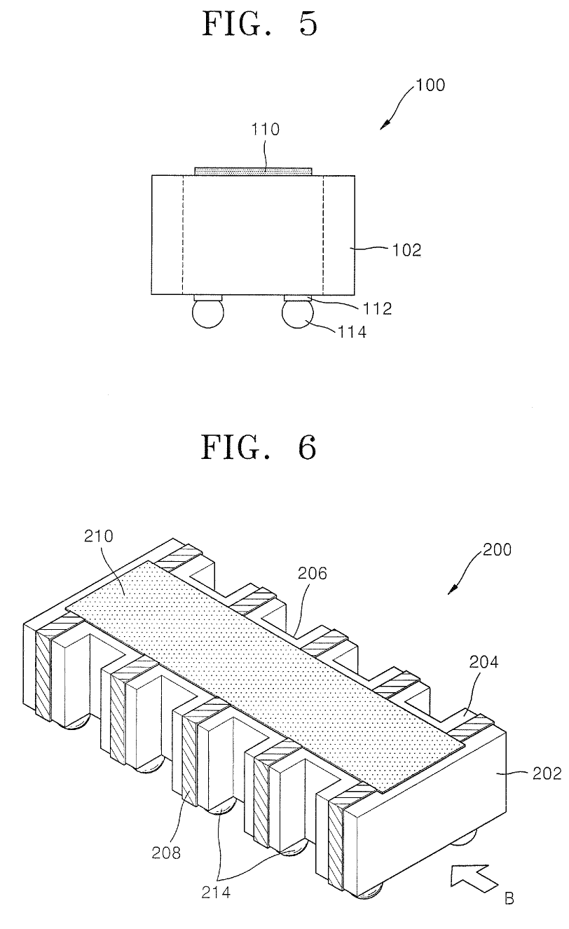

FIG. 3 is a perspective view of a chip network resistor contacting a PCB through solder balls according to an embodiment of the present invention, FIG. 4 is a bottom view of the chip network resistor of FIG. 3, and FIG. 5 is a front view of the chip network resistor of FIG. 3 viewed from direction A.

Referring to FIGS. 3 through 5, a chip network resistor 100 according to the present embodiment includes a body 102 having an uneven structure and including convex parts 104 and concave parts 106. A mixture of aluminum and polymer may be sintered at a temperature of 850° C. or more to form the body 102.

A resistor 110 is formed on the body 102. According to some embodiments, the resistor 110 comprises RuO. A wire line 108, connected to the resistor 110, extends to a lower surface of the body 102 through the concave parts 106. The wire line 108 is connected to pads as external electrodes 112 underneath the body 102 as shown in FIG. 4, and solder balls 114 are adhered onto the pads. The external electrodes 112 may be formed of copper (Cu) or silver (Ag). Also, the external electrodes 112 each have a square shape in FIG. 5 but may be modified into other forms.

An insulator (not shown) may be further over-coated on the resistor 110 and may comprise glass. The insulator may cover an entire portion of the body 102 of the chip network resistor 100 except for the pads used as the external electrodes 112.

The chip network resistor 100 according to the present embodiment is characterized in that the wire line 108 is installed on the concave parts 106, and thus stripping of the wire line 108 caused by an external force can be reduced. Also, the external electrodes 112 are formed on a lower surface of the body 102 not on a side of the body 102, contrary to the conventional art. Thus, cracking of the external electrodes 112 caused by an external force can be minimized.

The chip network resistor 100 is connected to the PCB through the solder balls 114 formed under the body 102. Thus, the chip network resistor 100 may be mounted on the PCB using only a lower surface of the chip network resistor 100 not a side of the chip network resistor 100. Thus, the chance of a crack occurring during a reliability inspection, such as a temperature cycle, is minimized so as to improve the reliability of solder bonding. For this purpose, the side of the body 102 of the chip network resistor 100 according to the present embodiment has a vertical shape not a convex shape. Also, a height of the chip network resistor 100 mounted on the PCB is increased. Thus, dissipation energy focused on the chip network resistor 100 can be reduced during an inspection of reliability. As a result, reliability of the chip network resistor 100 can be improved in a semiconductor module. Dotted lines of FIG. 5 indicate positions of the concave parts 106.

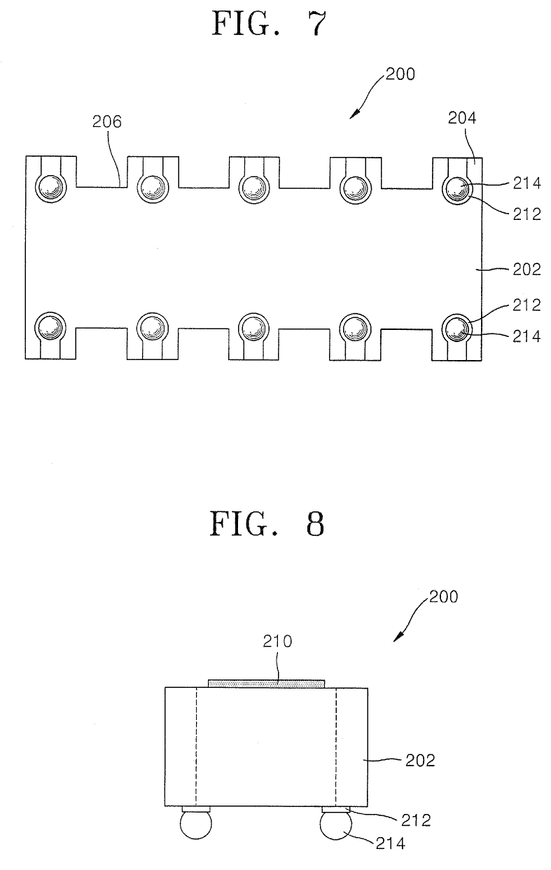

FIG. 6 is a perspective view of a chip network resistor contacting a PCB through solder balls according to another embodiment of the present invention, FIG. 7 is a bottom view of the chip network resistor of FIG. 6, and FIG. 8 is a front view of the chip network resistor of FIG. 6 viewed from direction B.

Referring to FIGS. 6 through 8, like the chip network resistor 100 of the previous embodiment, a chip network resistor 200 according to the present embodiment includes a body 202 having an uneven structure and a resistor 210 formed on the body 202. The resistor 210 is connected to a wire line 208 which extends to a lower surface of the body 202 along convex parts 204 of the body 202. The wire line 208 is connected to solder ball pads as external electrodes 212 on the lower surface of the body 202 as shown in FIG. 7. Solder balls 214 are respectively adhered onto the external electrodes 212.

The chip network resistor 200 of the present embodiment is different from the chip network resistor 100 of the previous embodiment in that the wire line 208 is formed on the convex parts 204 of the body 202 not on concave parts 206. Other elements of the chip network resistor 200 are the same as those of the chip network resistor 100, and thus their detailed descriptions will be omitted herein.

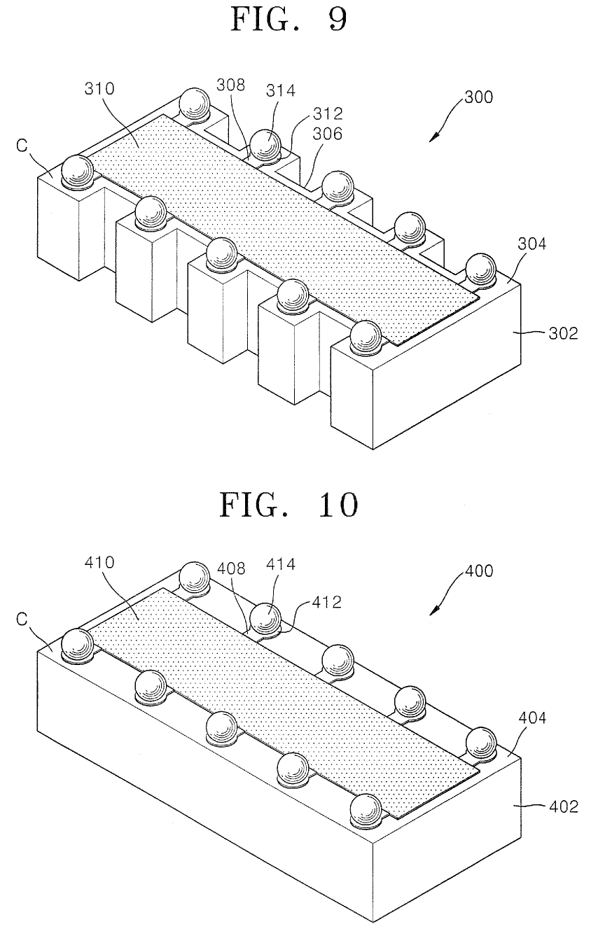

FIG. 9 is a perspective view of a chip network resistor contacting a PCB through solder balls according to another embodiment of the present invention.

The chip network resistors 100 and 200 of the previous embodiments include external electrodes formed on lower surfaces of the respective bodies. However, a chip network resistor 300 according to the present embodiment includes external electrodes 312 formed on an upper surface of a body 302 not on a lower surface of the body 302. In other words, a resistor 310 is formed on the body 302 which includes convex parts 304 and concave parts 306 and has an uneven structure, and the external electrodes 312 having solder ball pad shapes are directly connected to the resistor 310 through a wire line 308 on the body 302. Thus, when the chip network resistor 300 is mounted on the PCB, an upper surface C of the chip network resistor 300 is adhered onto the PCB, which is different from the chip network resistors 100 and 200 of the previous embodiments. Solder balls 314 as external connectors are adhered on the external electrodes 312.

FIG. 10 is a perspective view of a chip network resistor contacting a PCB through solder balls according to yet another embodiment of the present invention. The body 302 of the chip network resistor 300 (as shown in FIG. 9) is formed of a mixture of alumina and polymer and has an uneven shape. However, referring to FIG. 10, a chip network resistor 400 according to the present embodiment has a rectangular shape. Thus, a wire line 408, external electrodes 412, and solder balls 414 are formed at an edge of a body 402 on which a resistor 410 is formed. Also, when the chip network resistor 400 is mounted on the PCB, an upper surface C of the chip network resistor 400 is adhered on the PCB, which is different from the chip network resistors 100 and 200 of the previous embodiments.

In a chip network resistor contacting a PCB through solder balls according to the present invention, external electrodes may be formed on an upper or lower surface of a body. Also, the body may have an uneven shape, a rectangular shape, or the like.

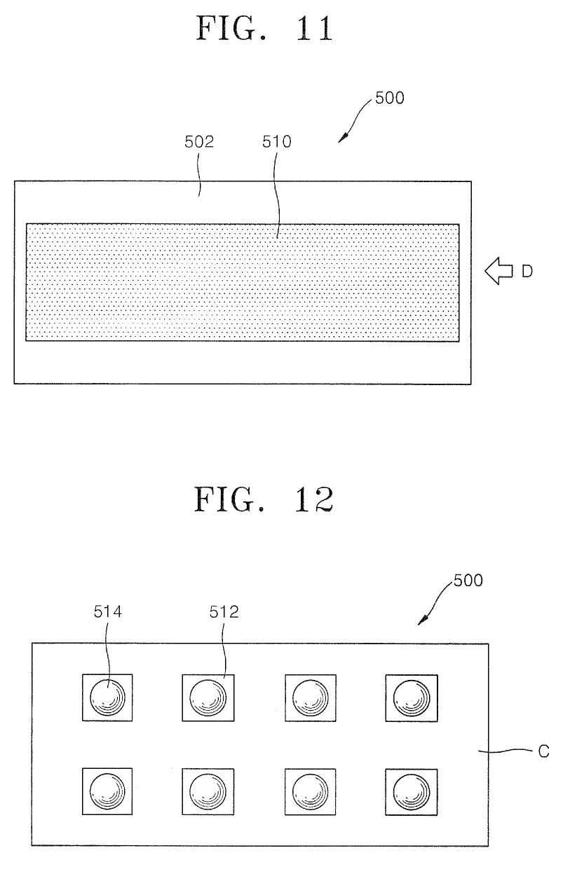

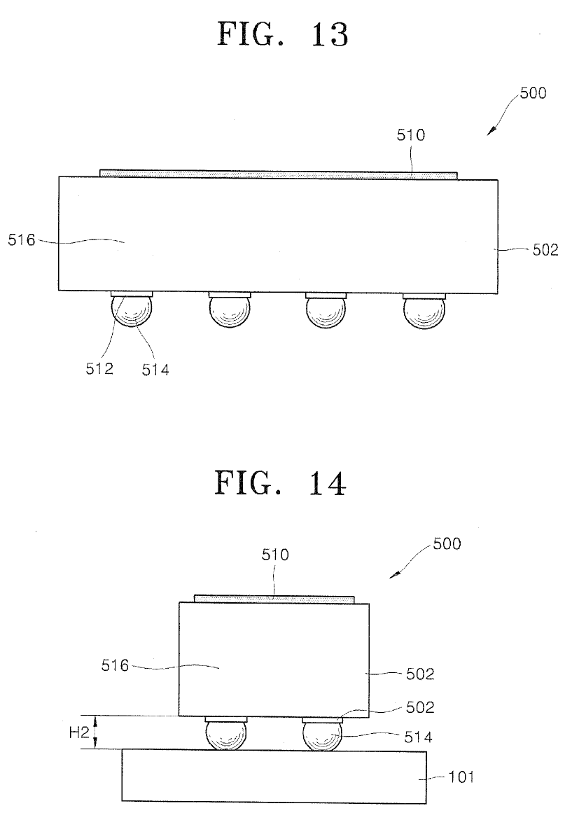

FIG. 11 is a perspective view of a chip network resistor contacting a PCB through solder balls according to still another embodiment of the present invention, FIG. 12 is a bottom view of the chip network resistor of FIG. 11, FIG. 13 is a side view of the chip network resistor of FIG. 11, and FIG. 14 is a front view of the chip network resistor of FIG. 11 viewed from direction D.

Referring to FIGS. 11 through 14, a chip network resistor 500 according to the present embodiment includes a body 502 having a rectangular shape. A resistor 510 is formed of RuO on the body 502 as shown in FIG. 11. Throughholes 516 are formed in the body 12 as shown in FIG. 13, and a conductive material, e.g., paste containing copper or silver, is filled in the througholes 516. Here, the number of throughholes 516 is equal to the number of external electrodes 512 having solder ball pad patterns. Thus, the resistor 510 is connected to the external electrodes 512 on a lower surface of the body 502 through the conductive material filled in the throughholes 516. Solder balls 514 are connected to surfaces of the external electrodes 512 and thus used to bond the chip network resistor 500 to a PCB.

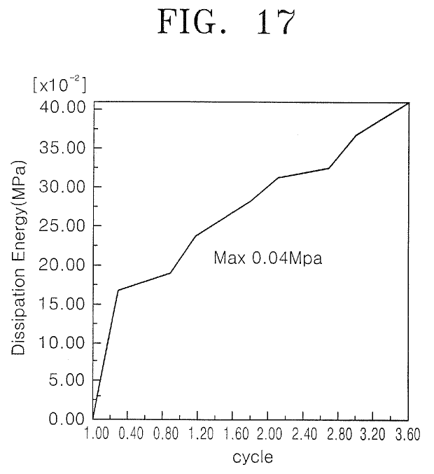

The chip network resistor 500 according to the present embodiment is bonded to the PCB 101 through the solder balls 514. Thus, a bonding height H2 of the chip network resistor 500 to the PCB 101 is higher than a bonding height H1 of the chip network resistor 10 of FIG. 2, i.e., about 200 μm. As a result, reliability of the chip network resistor 500 can be further improved in an inspection of reliability, such as a temperature cycle. This will be described in detail later with reference to results of simulations, as shown in FIGS. 16 and 17.

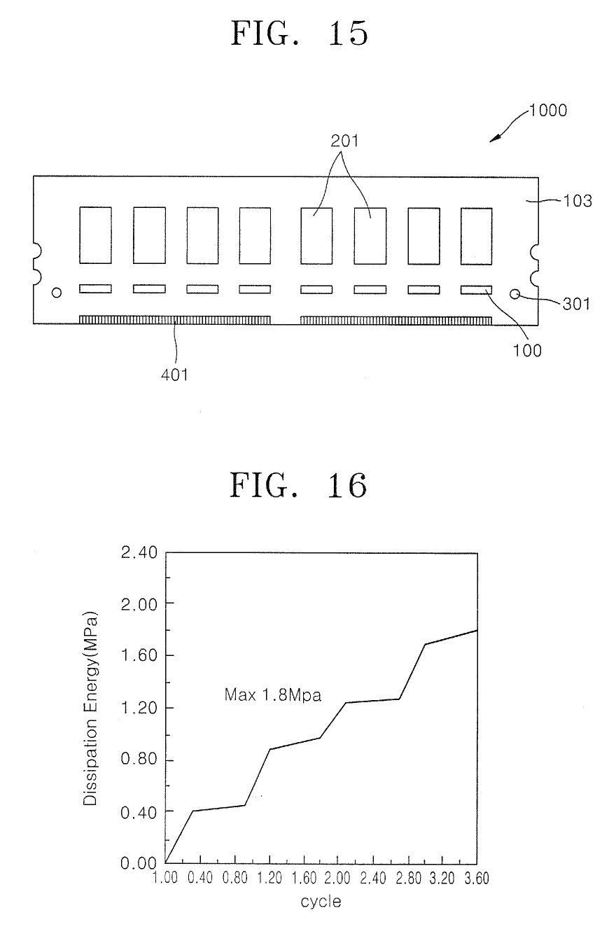

FIG. 15 is a plan view of a semiconductor module including a chip network resistor contacting a PCB through solder balls according to an embodiment of the present invention. Referring to FIG. 15, a semiconductor module 1000 according to the present embodiment includes a module board 103, a plurality of semiconductor packages 201, and a plurality of chip network resistors 100. The plurality of semiconductor packages 201 are mounted on the module board 103. The plurality of chip network resistors 100 are mounted on the module board 103 through solder balls and include external electrodes which are not exposed on the sides of the chip network resistors 100.

Here, the module board 103 may be modified into other forms, and the semiconductor packages 201 may be modified into other forms as is known by those of ordinary skill in the art. The chip network resistors 100 may be replaced with any of the chip network resistors 200, 300, 400, and 500 of the previous embodiments. The position and number of the chip network resistors 100 may be variously changed as is known by those of ordinary skill in the art. Reference numeral 301 denotes arrangement holes formed in the module board 103, and reference numeral 401 denotes external connectors of the module board 103.

According to the present invention, a lower surface of the chip network resistor can be bonded to a PCB rather than a side of a chip network resistor. Thus, damage from an external force can be minimized in the chip network resistor. Also, a bonding height of the chip network resistor can be increased to improve quality of the chip network resistor in an inspection of reliability.

Characteristics of the chip network resistor 10 of FIG. 2 and the chip network resistor 500 of FIG. 14 were confirmed through inspections of reliability, such as temperature cycles.

In the inspections of reliability, such as the temperature cycles, the chip network resistors 10 and 500 are left for 10 minutes at a temperature of −25° C., and then for 10 minutes at a high temperature of 125° C. Here, a one-time movement from −25° C. to 125° C. is defined as 1 cycle.

FIG. 16 is a graph illustrating dissipation energy of a chip network resistor having a structure as illustrated in FIG. 2 in an inspection of reliability, and FIG. 17 is a graph illustrating dissipation energy of a chip network resistor having a structure as illustrated in FIG. 14 in an inspection of reliability.

Referring to each of FIGS. 16 and 17, the X axis denotes a cycle, and the Y axis denotes a stress value absorbed into a mounting height of a chip network resistor, e.g., dissipation energy having a unit of MPa. Graphs of FIGS. 16 and 17 show results of simulations of analyzing stresses applied to the chip network resistors using dissipation energies according to mounting heights of the chip network resistors.

If the chip network resistor 10 of FIG. 2 is mounted on a PCB at a height of 30 μm, i.e., the height H1 of FIG. 2, a maximum value of energy applied to the chip network resistor 10 during the temperature cycle is 1.8 MPa. If a mounting height of the chip network resistor 500 of FIG. 14, i.e., the height H2 of FIG. 14, is increased within a range of 200 μm due to solder balls, a maximum value of energy applied to the chip network resistor 500 is lowered to 0.04 MPa. Thus, a maximum value of energy applied to a chip network resistor in an inspection of reliability is lowered by about 45 times. Thus, reliability is significantly improved.

According to an aspect of the present invention, there is provided a chip network resistor, including: a body comprising an insulating material; a resistor disposed on the body; external electrodes connected to the resistor and disposed on a lower surface of the body; and conductive balls adhered on the external electrodes.

The body may include convex parts and concave parts.

If the body includes convex and concave parts, the body may include a wire line which is connected to the resistor through sides of the convex parts to extend to a lower surface of the body. The external electrodes may be connected to the wire line installed on the convex parts to be formed on the lower surface of the body.

If the body is rectangular, the body may include throughholes, wherein the number of throughholes is equal to the number of external electrodes. The throughholes may be filled with a conductive material.

The chip network resistor may further include an insulator covering an upper part of the resistor. The insulator may be formed of glass.

According to another aspect of the present invention, there is provided a chip network resistor, including: a body comprising an insulating material; a resistor disposed on the body; external electrodes connected to the resistor through a wire line; an insulator covering the wire line and the resistor and exposing the external electrodes; and conductive balls adhered on the external electrodes.

The body may have an uneven structure, or a rectangular shape. The external electrodes may be formed on convex parts of the body, or at an edge of the body on which the resistor is formed.

According to another aspect of the present invention, there is provided a semiconductor module including: a module board on which a plurality of semiconductor packages are mounted; and a chip network resistor mounted on the module board using conductive balls and comprising external electrodes which are not exposed.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A chip network resistor, comprising:
a body comprising an insulating material;
a resistor disposed on the body;
external electrodes connected to the resistor and disposed on a lower surface of the body; and
conductive balls adhered on the external electrodes.

2. The chip network resistor of claim 1, wherein the insulating material of the body comprises alumina and a polymer.

3. The chip network resistor of claim 1, wherein the body comprises convex parts and concave parts.

4. The chip network resistor of claim 1, wherein the body has a rectangular shape.

5. The chip network resistor of claim 1, wherein the external electrodes comprise one of copper (Cu) and silver (Ag).

6. The chip network resistor of claim 1, further comprising an insulator covering an upper part of the resistor.

7. The chip network resistor of claim 6, wherein the insulator comprises glass.

8. The chip network resistor of claim 3, wherein the body comprises a wire line which is connected to the resistor through sides of the convex parts and extends to a lower surface of the body.

9. The chip network resistor of claim 8, wherein the external electrodes are connected to the wire line installed on the convex parts.

10. The chip network resistor of claim 3, wherein the body comprises a wire line which is connected to the resistor through sides of the concave parts and extends to a lower surface of the body.

11. The chip network resistor of claim 10, wherein the external electrodes are connected to the wire lines installed on the concave parts.

12. The chip network resistor of claim 4, wherein the body comprises throughholes, wherein the number of throughholes is equal to the number of external electrodes.

13. The chip network resistor of claim 12, wherein the throughholes are filled with a conductive material.

14. The chip network resistor of claim 13, wherein the conductive material filled in the throughholes is one of a paste comprising copper and a paste comprising silver.

15. A chip network resistor, comprising:
a body comprising an insulating material;
a resistor disposed on the body;
external electrodes connected to the resistor through a wire line disposed on an upper surface of the body;
an insulator covering the wire line and the resistor and exposing the external electrodes; and
conductive balls adhered on the external electrodes.

16. The chip network resistor of claim 15, wherein the body has an uneven structure.

17. The chip network resistor of claim 15, wherein the body has a rectangular shape.

18. The chip network resistor of claim 16, wherein the external electrodes are disposed on convex parts of the body.

19. The chip network resistor of claim 17, wherein the external electrodes are disposed at an edge of the body on which the resistor is disposed.

20. A semiconductor module comprising:
a module board on which a plurality of semiconductor packages are mounted; and
a chip network resistor mounted on the module board using conductive balls and comprising external electrodes which are not exposed on sides of the chip network resistor.
